(19) United States
(12) Patent Application Publication
(10) Pub. No.: US 2026/0089485 A1
(43) Pub. Date: Mar. 26, 2026

(54) NATIONAL ROAMING MOBILITY REJECTION MANAGEMENT

(71) Applicant: RAKUTEN SYMPHONY, INC., Tokyo (JP)

(72) Inventors: Hanumantappa KORACHARA MAREPPA, Karnataka (IN); Ankush KUMAR, Karnataka (IN); Manikanta KAMISETTY, Karnataka (IN); Rohan Ramakrishna PRABHU GURUPUR, Karnataka (IN)

(73) Assignee: RAKUTEN SYMPHONY, INC., Tokyo (JP)

(21) Appl. No.: 19/256,245

(22) Filed: Jul. 1, 2025

(30) Foreign Application Priority Data
Sep. 26, 2024 (IN) 202411072767

(51) Int. Cl. H04W 8/16; H04W 36/00; H04W 60/00

(52) U.S. Cl. CPC H04W 8/16; H04W 36/0079; H04W 60/00

(57) ABSTRACT

Disclosed is an apparatus (600) that is configured to receive mobility reject information and neighbor information from each of a plurality of eNodeBs (eNBs) (202). The apparatus is configured to identify a change in registered configuration for at least one eNB (202) based on received mobility reject information and the neighbor information. The apparatus is also configured to transmit at least one of a configuration change command and a notification to each of the neighboring eNBs (202) corresponding to the at least one eNB (202). The configuration change command is transmitted to change the registered configuration of the at least one eNB (202) at the corresponding neighboring eNB based on the identified change in the registered configuration. The notification indicates the change of the registered configuration of the at least one eNB (202).

### CROSS-REFERENCE TO RELATED APPLICATION(S)

This application claims priority to Indian non-provisional patent application Ser. No. 202411072767, filed on Sep. 26, 2024, the entire contents of which are incorporated herein by reference.

### FIELD

The present disclosure relates to national roaming mobility rejection management.

### BACKGROUND

The information disclosed in this background section is only for the enhancement of understanding of the general background of the disclosure and should not be taken as an acknowledgment or any form of suggestion that this information forms the prior art already known to a person skilled in the art.

Wireless communication for mobile devices (or User Equipment (UEs)) on the move is based in part on handovers (HOs) between a serving cell and a target cell. A handover occurs when a UE transitions from one cell's coverage area to another. The handover can happen for various reasons, including the UE's movement out of a current cell's range (e.g., driving out of a coverage area) or changes in network conditions (e.g., congestion or poor signal). Typically, the handovers are classified as one of an intra-operator handover or an inter-operator handover. The intra-operator handover occurs when the UE transits from one cell to another cell which is also managed by the same Mobile Network Operator (MNO). The intra-operator handovers generally happen with minimal disruption, as the network is designed to manage these transitions seamlessly. The inter-operator handover refers to a handover process between cells managed by different MNOs. In the inter-operator handover, additional complexity arises due to differences in network architecture, policies, and agreements between operators.

### SUMMARY

This summary is provided to introduce a selection of concepts, in a simplified format, that are further described in the detailed description of the disclosure. This summary is neither intended to identify key or essential inventive concepts of the disclosure nor is it intended to determine the scope of the disclosure.

Disclosed herein is an apparatus. The apparatus is configured to receive mobility reject information and neighbor information from each of a plurality of eNodeBs (eNBs). The apparatus is configured to identify a change in registered configuration for at least one eNB among the plurality of eNBs based on received mobility reject information and the neighbor information. The apparatus is also configured to transmit at least one of a configuration change command and a notification to each of the neighboring eNBs corresponding to the at least one eNB. The configuration change command is transmitted to change the registered configuration of the at least one eNB at the corresponding neighboring eNB based on the identified change in the registered configuration. The notification indicates the change of the registered configuration of the at least one eNB.

Disclosed herein is a method. The method includes receiving, by a Service Management and Orchestration (SMO), mobility reject information and neighbor information from each of a plurality of eNodeBs (eNBs). The method also includes identifying, by the SMO, a change in registered configuration for at least one eNB among the plurality of eNBs based on received mobility reject information and the neighbor information. The method includes transmitting, by the SMO, at least one of a configuration change command and a notification to each of the neighboring eNBs corresponding to the at least one eNB. The configuration change command is transmitted to change the registered configuration of the at least one eNB at the corresponding neighboring eNB based on the identified change in the registered configuration. The notification indicates the change of the registered configuration of the at least one eNB.

Disclosed herein is a non-transitory computer-readable medium storing instructions. The instructions comprising one or more instructions that are executed by a Service Management and Orchestration (SMO). The instructions cause the one or more processors to receive mobility reject information and neighbor information from each of a plurality of eNodeBs (eNBs). The instructions cause the one or more processors to identify a change in registered configuration for at least one eNB among the plurality of eNBs based on received mobility reject information and the neighbor information. The instructions cause the one or more processors to transmit at least one of a configuration change command and a notification to each of the neighboring eNBs corresponding to the at least one eNB. The configuration change command is transmitted to change the registered configuration of the at least one eNB at the corresponding neighboring eNB based on the identified change in the registered configuration. The notification indicates the change of the registered configuration of the at least one eNB.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a roaming scenario of restricted handover, according to a conventional technique;

FIG. 2 illustrates a schematic block diagram of a system to perform roaming mobility rejection management, in accordance with an embodiment of the present disclosure;

FIG. 3 illustrates a sequence flow diagram illustrating NETCONF session establishment, in accordance with an embodiment of the present disclosure.

FIG. 4 illustrates a sequence flow diagram illustrating NETCONF session termination, in accordance with an embodiment of the present disclosure.

FIG. 5 illustrates a flowchart depicting a method for performing roaming mobility rejection management, in accordance with an embodiment of the present disclosure; and

FIG. 6 is a diagram of example components of a wireless communication device, in accordance with an embodiment of the present disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from the practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

The terms “mobile device”, “user device”, “User Equipment”, and “UE” may be used interchangeably throughout the description.

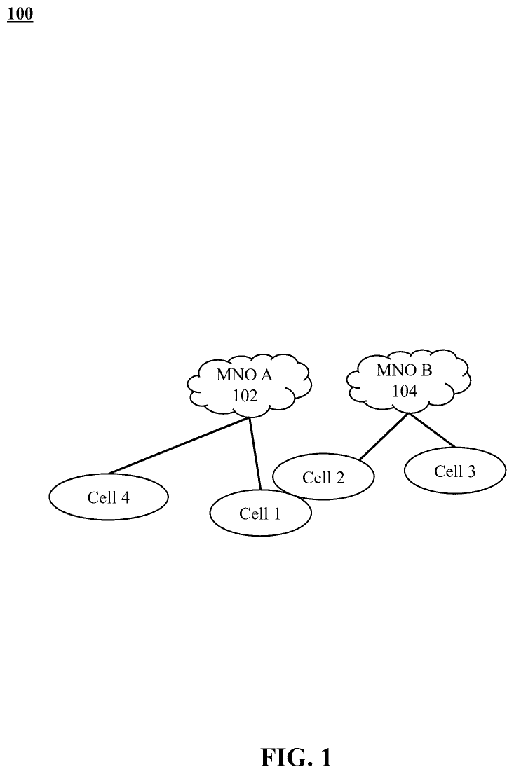

FIG. 1 illustrates a roaming scenario 100 of restricted Handover (HO), according to a conventional technique. FIG. 1 illustrates a Mobile Network Operator (MNO) A 102 and an MNO B implementing one or more cells. In the illustrated embodiment, the MNO A 102 implements a cell 1 and a cell 4 and the MNO B 104 implements a cell 2 and a cell 3. The cells 1 and 2 may be implemented adjacent to each other. For instance, the cell 1 may act as a neighbor for the cell 2 and vice-versa. The MNO A 102 and the MNO B 104 provide wireless communication services to mobile devices, such as smartphones, tablets, and IoT devices. The MNO A 102 and the MNO B 104 are responsible for managing, operating, and maintaining an infrastructure required for mobile networking, which includes cellular networks, Radio Access Networks (RAN), and core network elements. The cells 1, 2, 3, and 4 may refer to geographical areas covered by corresponding eNodeB (eNBs) in a mobile network provided by the MNO A 102 and the MNO B 104. The cells 1, 2, 3, and 4 work together to manage the mobility of user devices. For example, when a mobile device moves from one cell to another, the MNO's network facilitates handovers to ensure continuous service and minimal disruption.

However, in conventional wireless systems, when a mobile device from a cell that is “opened” for roaming to another cell that is “not opened” for roaming, the handover is restricted.

For example, in the illustrated embodiment, the MNO A 102 and the MNO B 104 agree on enabling roaming to the cell 2 of the MNO B 104, whereas roaming to the cell 3 is kept disabled. Furthermore, when the MNO A 102 faces an outage in a region including the cell 1, the MNO A 102 requests the MNO B 104 to accept roaming of its subscribers to a region that covers the cell 1. However, the MNO B 104 has set, in System Information Block 1 (SIB1) broadcasted in the cell 2, a cellReservedForOperatorUse=“not reserved” for a Public Land Mobile Network (PLMN) ID that is used for roaming. Further, in the cell 3, the cellReservedForOperatorUse is set to “reserved” to prevent roaming UEs from accessing the cell 3. Also, the UEs (i.e., the subscribers) of the MNO A 102 are configured with the PLMN IDs that are used for roaming. Therefore, once a UE loses connection in the cell 1, the UE will initiate a cell selection procedure. Since the cellReservedForOperatorUse in the cell 2 is set as “not reserved” for the roaming PLMN IDs, the UE will select the PLMN and connect to the cell 2. When the UE moves from the cell 2 to the cell 3, a handover may be triggered by the eNB associated with the cell 2. However, since the cellReservedForOperatorUse is set to “reserved” for the cell 3 for the roaming PLMN IDs, the handover to the cell 3 may be rejected. Specifically, in a cell, the cellReservedForOperatorUse= “reserved” may indicate that the corresponding MNO has restricted the roaming UEs to prevent access to the corresponding cell.

For instance, if a handover request for a target cell for which the cellReservedForOperatorUse=“reserved” and a rejectToreserved cell is set to true for the PLMN, then the target cell will send handover preparation failure with cause as “cell not available”. In such a case, the source cell and/or the corresponding eNB may move that cell (i.e., the neighbor) to an un-preferred list and a handover may not be allowed till a predefined timer is expired. For example, the predefined timer may be “hoRestrictionTimerForReservedCell” timer with an expiry time of 0, 5 mins, 10 mins, 20 mins, or 60 mins.

Moreover, in the above scenario, when a target cell configuration is changed dynamically i.e., either the cellReservedForOperatorUse is changed from “reserved” to “unreserved”, or “rejectToreserved” flag is set to false, the source eNB and/or the cell may not be aware of such update. A UE that tried for the HO to that cell, which is now in the un-preferred list, the UE is prohibited from performing the HO to that cell till the configured timer is expired. Therefore, the UE is prevented from accessing the target cell with is in the un-preferred list till the configured timer, even when the target cell is now able to serve the UE. This leads to a bad user experience for the UE.

The present disclosure aims to solve one or more of the above-mentioned problems to improve handover management during mobility.

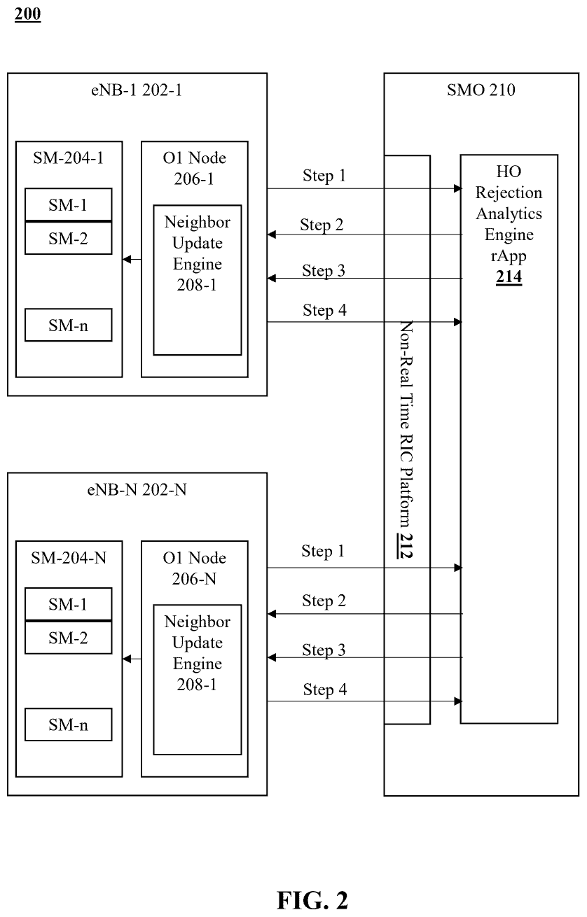

FIG. 2 illustrates a schematic block diagram of a system 200 to perform roaming mobility rejection management, in accordance with an embodiment of the present disclosure. The system 200 may include a plurality of eNBs (for example, eNB-1 202-1 to eNB-N 202-N) and a SMO 210. For the sake of brevity, the plurality of eNBs may be referred to as eNBs 202. The eNBs 202 may correspond to one or more cells associated with one or more MNOs. The eNBs 202 may be configured to provide radio access to mobile devices. The eNBs 202 may act as an interface between UEs and the core network. The eNBs 202 may be configured to perform various signal processing functions such as, but not limited to, modulation, demodulation, coding-decoding, and so forth. Each eNB 202 may manage radio resources for the UEs within the corresponding coverage area (i.e., the cell). The eNBs 202 may facilitate handovers between cells to maintain active connections as users move in and out of different coverage areas. Each eNB 202 may coordinate with neighboring eNBs (also referred to as neighbors) to ensure a seamless transition. The eNBs 202 may also be configured to track the location of the associated UEs for mobility management. The eNBs 202 may further be configured to establish and release connections with the UEs and/or other entities of the network. Such sessions may include Network Configuration Protocol (NETCONF) sessions.

In one or more non-limiting embodiments of the present disclosure, each eNB 202 may include one or more Subscriber Managers (SMs) and an O1 node. The O1 node may include a neighbor update engine. For example, the eNB-1 202-1 may include SMs 204-1 and an O1 node 206-1. The O1-node 206-1 may include a neighbor update engine 208-1. The SMs 204-1 may act as a functional component configured to manage interactions and data related to mobile subscribers connected to the eNB-1 202-1. The SMs 204-1 may be configured to identify and authenticate mobile devices (or UEs) that are connected to the eNB-1 202-1. For instance, the SMs 204-1 may validate an International Mobile Subscriber Identity (IMSI), a Temporary Mobile Subscriber Identity (TMSI), and other related information associated with each of the mobile devices connected to the eNB-1 202-1. In one embodiment, the SMs 204-1 may manage the establishment, modification, and release of data sessions for each of the mobile devices (and/or the subscribers). The SMs 204-1 may also allocate radio resources for each connected subscriber based on current network conditions, subscriber profiles, and policies. In some embodiments, the SMs 204-1 may also perform mobility management. For instance, the SMs 204-1 may coordinate with a Mobility Management Entity (MME) (not shown) to manage location updates and handovers corresponding to each of the subscribers. In one or more embodiments, the SMs 204-1 may be implemented as one or more applications configured to perform the one or more above-mentioned functions/operations.

The O1 node 206-1 may act as an interface between the SMs 204-1 and the SMO 210. The O1 node 206-1 may communicate with the SMO 210 via an O1 interface. The O1 node 206-1 may be configured to collect and report network data, configuration management, fault management, and monitoring performance of the network. The O1 node 206-1 may be configured to receive configuration updates and/or parameters from the SMO 210 via the O1 interface. In some embodiments, the configuration updates and/or the parameters may relate to Radio Resource Management (RRM), Quality of Service (QoS) policies, and software or firmware updates. In one or more embodiments, the O1 node 206-1 may enable the eNB-1 202-1 to report faults or alarms to the SMO 210. The O1 node 206-1 may also facilitate the transmission of performance data and statistics from the eNB-1 202-1 to the SMO 210. The O1 node 206-1 may also support other necessary interfaces required to perform transmission and reception of data to the SMO 210 and from the SMO 210.

The O1 node 206-1 may also include the neighbor update engine 208-1. The neighbor update engine 208-1 may be implemented in a hardware, a software, or a combination of hardware and software. The neighbor update engine 208-1 may be configured to maintain information of each of the neighboring eNBs and/or cells. The information associated with the neighboring eNBs and/or cells may include, but is not limited to, a status of the cellReservedForOperatorUse and a status of the rejectToreserved flag corresponding to each of the neighboring eNBs/cells (for example, eNB-2 202-2 to eNB-N 202-N). In one embodiment, the information may also include the un-preferred list of eNBs for the HO process.

While components associated with eNB-1 202-1 have been explained in preceding paragraphs, the description of components is equally applicable for other eNBs 202.

Each of the eNBs 202 may be connected with the SMO 210. The SMO 210 facilitates management, orchestration, and optimization of Radio Access Networks (RANs). The SMO 210 enables operators to effectively manage multi-vendor RAN deployments and implement flexible, automated network operations, significantly enhancing efficiency and service delivery. In one embodiment, the SMO 210 may be configured to orchestrate resources across the RAN, including the configuration, management, and coordination of various elements of the eNBs 202. The SMO 210 may be configured to maintain service assurance and quality. In one embodiment, the SMO 210 may be configured to define and enforce policies related to network behavior and/or resource management. In one or more embodiments, the SMO 210 may implement advanced analytics and Machine Learning (ML) techniques to perform required actions based on the data collected over the network. This enables the SMO 210 to optimize network performance and enhance user experience.

In one embodiment, the SMO 210 may include a Non-Real Time RAN Intelligent Controller (Non-RT RIC) platform 212. The non-RT RIC platform 212 may operate at a higher layer and perform management and optimization of RANs. In some embodiments, the non-RT RIC platform 212 may utilize the advanced data analytics and the ML techniques to analyze RAN performance, optimize resource allocation, and implement network policies, thereby enhancing overall network efficiency and user experience.

The SMO 210 may also implement one or more rApps. The rApps may correspond to modular applications designed to be executed on the non-RT RIC platform 212. The rApps may provide value-added services related to RAN optimization and procedure optimization through the non-RT RIC platform 212. In one embodiment, the SMO may implement a HO Rejection Analytics Engine rApp 214 (also referred to as the rApp 214). The rApp 214 may be configured to perform national mobility handover rejection management as per the present disclosure. In one or more embodiments, the rApp 214 may be configured to communicate with each of the eNB 202.

The rApp 214 may be configured to maintain a list of cells for which a handover rejection flag is set to true, and the cell is reserved for the corresponding eNB. In one embodiment, each eNB 202 may inform/update the reject-to-reserved (also referred to as rejectToreserved) cell information along with the corresponding neighboring eNBs' information to the rApp 214. The eNBs 202 may communicate said information to the rApp 214 via the O1 interface. The rApp 214 may be configured to monitor and/or identify any change in the registered and/or previously stored configuration corresponding to any of the eNB 202. In case the rApp 214 identifies any change in the configuration corresponding to any of the eNBs 202, the rApp 214 may be configured to notify each of its neighboring eNBs 202, of the identified change. This enables the neighboring eNBs 202 to dynamically update the status of the corresponding eNB 202. For instance, the neighboring eNBs 202 may remove the eNB from the un-preferred list.

In one embodiment, each of the eNBs 202 and the rApp 214 may perform a set of Remote Procedure Call (RPC) procedures. For instance, the eNB-1 202-1 may perform one or more operations illustrated steps 1 to 4. In case eNB-1 202-1 performs a configuration change, the eNB-1 202-1 may perform step 1 to notify the configuration change to the rApp 214. The step 1 may correspond to the RPC edit configuration command that indicates the creation and/or merger of configuration information. In response to the RPC command at step 1, the rApp 214 may perform step 2 to notify that the configuration change information has been successfully recorded. For instance, the rApp 214 may revert with an RPC edit configuration message with a reply as “Ok”. In case the rApp 214 identifies a change in the configuration information of the neighboring cells/eNBs of the eNB-1 202-1, the rApp 214 may perform step 3 to indicate the identified change to the eNB-1 202-1. The step 3 may correspond to step 1 as performed by the eNB-1 202-1. In response to the received indication for the identified change, the eNB-1 202-1 may perform the step 4. The step 4 may correspond to the step 2 as performed by the rApp 214. Similar operations may be performed between each of the eNBs 202 and the SMO 210 and/or rApp 214.

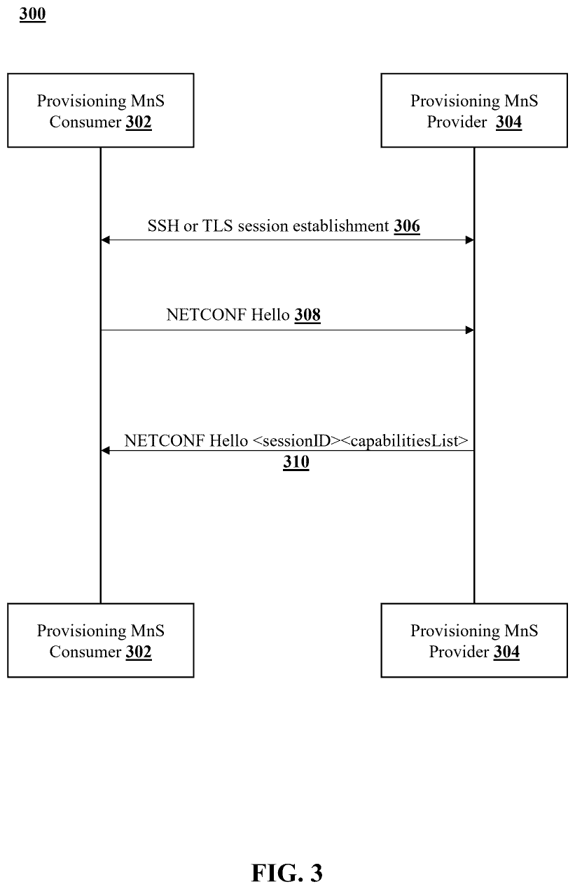

FIG. 3 illustrates a sequence flow diagram 300 illustrating a NETCONF session establishment, in accordance with an embodiment of the present disclosure. The sequence flow diagram 300 may illustrate a sequence of operations between a provisioning Management Service (MnS) consumer 302 (also referred to as the MnS consumer 302) and a provisioning MnS provider 304 (also referred to as the MnS provider 304). In an embodiment, the MnS consumer 302 may correspond to any of the eNBs 202 and the MnS provider 304 may correspond to the SMO 210. In an embodiment, each eNB 202 will establish a NETCONF connection with the SMO 210 and/or the rApp 214, as per the O1 interface standard. For instance, at step 306, a Secure Shell (SSH) or Transport Layer Security (TLS) session is established between the MnS consumer 302 and the MnS provider 304. When the NETCONF utilizes SSH protocol as the transport protocol, the SSH session is established, whereas when the NETCONF utilizes TLS as the transport protocol, the TLS session is established. At step 308, the MnS consumer 302 transmits a NETCONF hello message to the MnS provider 304. In response, at step 310, the MnS provider 304 may transmit a NETCONF hello message with a session ID and a capabilities list. The exchange of the NETCONF hello messages may initiate the session and establish the capabilities of both the MnS consumer 302 and the MnS provider 304. In one embodiment, the MnS consumer 302 may correspond to a MnS client, and the MnS provider 304 may correspond to a MnS server. When the MnS client sends the NETCONF hello message, the MnS client includes a payload including a list of capabilities supported by the MnS client. Similarly, the MnS server responds with a NETCONF hello message including a list of capabilities supported by the MnS server. Once the NETCONF session is established, the MnS consumer 302 and/or each eNB 202 may share a list of corresponding neighboring eNBs and cells that are registered as mobility reject cells with the SMO 210 and/or the rApp 214. In one embodiment, the eNB 202 may transmit the list of corresponding neighboring eNBs and the cells, in the edit-configuration RPC message, as indicated by the step 1 in FIG. 2. The MnS provider 304 and/or the SMO 210 may maintain the received list of neighboring eNBs and the cells from each of the eNB 202 and maintain a record of the received information. The MnS provider 304 and/or the SMO 210 may reply with an edit configuration RPC message indicating the reply as “OK”, as shown by step 2 in FIG. 2.

In case any change is detected for the cells registered as mobility reject cells, the rApp 214 and/or the SMO 210 may inform the mobility reject configuration to each of the neighboring eNBs. In one embodiment, the rApp 214 and/or the SMO 210 may inform the mobility reject configuration in an edit configuration RPC message, as shown by step 3 in FIG. 2. In one embodiment, the O1 node of each eNB 202 (for example, the O1-node 206-1) may receive the mobility reject configuration from the rApp 214. The O1-node 206-1 may pass the received mobility reject configuration to one of the SM 204-1. The SM 204-1 may remove/add the neighbors from/to the un-preferred list of eNBs/cells. Thus, the SMO 210 may enable each of the eNBs 202 to dynamically update the un-preferred list of eNBs/cells and to effectively perform the mobility reject handover procedure.

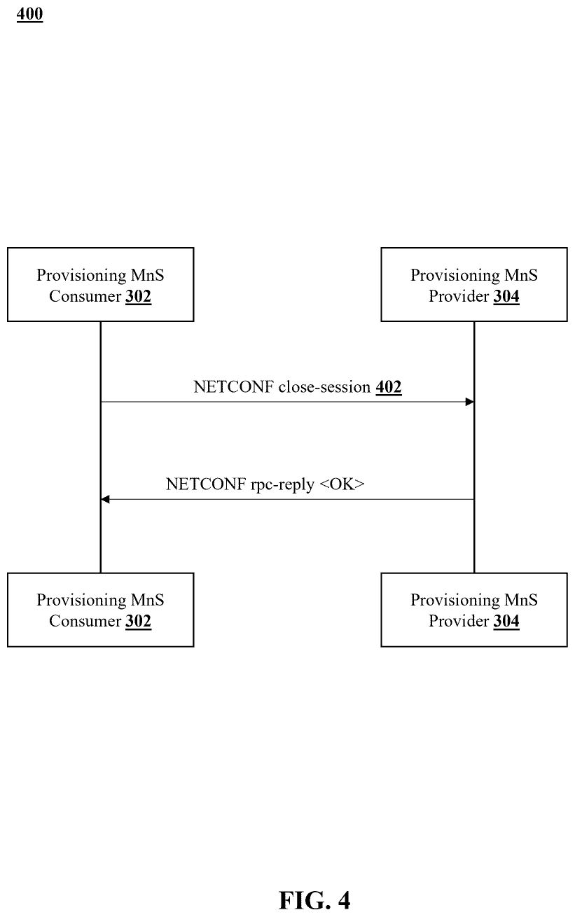

FIG. 4 illustrates a sequence flow diagram 400 illustrating NETCONF session termination, in accordance with an embodiment of the present disclosure. To terminate the NETCONF session, at step 402, the MnS consumer 302 may transmit a NETCONF close session command/message to the MnS provider 304. In response to the received NETCONF close session command/message, at step 404, the MnS provider 304 may revert with a NETCONF RPC reply with status as “OK”. The NETCONF RPC reply may indicate a successful termination of the NETCONF session between the MnS consumer 302 and the MnS provider 304.

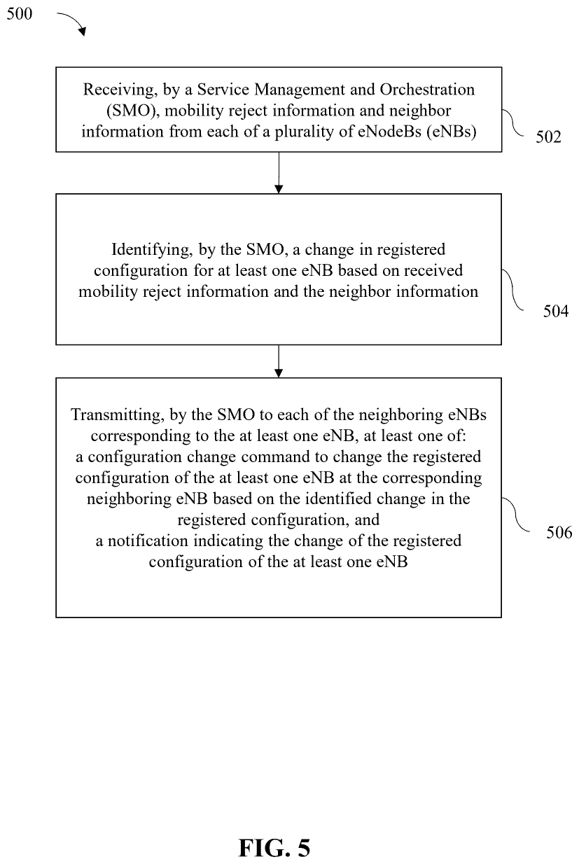

FIG. 5 illustrates a flowchart depicting a method 500 for performing roaming mobility rejection management, in accordance with an embodiment of the present disclosure. The method 500 may be performed by the SMO 210.

At step 502, the SMO 210 may receive mobility reject information and neighbor information from each of the eNBs 202. In one embodiment, the mobility reject information may include a list of cells that are reserved for the corresponding eNB 202. The list of cells that are reserved for the corresponding eNB 202 are prevented from performing handover for mobility UEs. The neighbor information may include the un-preferred list of neighboring eNBs. The un-preferred list of eNBs may include the eNBs and/or the cells for which a handover request has been rejected.

At step 504, the SMO 210 may identify a change in registered configuration for at least one eNB 202 based on received mobility reject information and the neighbor information. The registered confirmation may correspond to the stored mobility reject information and the neighbor information stored at the SMO 210 for the corresponding eNB 202.

At step 506, the SMO 210 may transmit a configuration change command to change the registered configuration of the at least one eNB 202, at the corresponding neighboring eNB based on the identified change in the registered configuration, to each of the neighboring eNBs corresponding to the at least one eNB. Further, the SMO 210 may transmit a notification indicating the change of the registered configuration of the at least one eNB to each of the neighboring eNBs corresponding to the at least one eNB.

In one embodiment, the SMO 210 may establish a NETCONF session with each of the eNBs 202. The NETCONF session may be established based on O1 standards.

In one embodiment, the SMO 210 may receive the mobility reject information and the neighbor information after every predefined time interval configured at each of the plurality of eNBs 202.

In one embodiment, the SMO 210 may receive the mobility reject information and the neighbor information in response to a change is identified by the corresponding eNB 202. In one embodiment, the mobility reject information indicates a flag (i.e., rejectToreserved) as true or false based on corresponding cell configuration (i.e., cellReservedForOperatorUse) as reserved or unreserved, respectively.

While the above-discussed steps in FIG. 5 are shown and described in a particular sequence, the steps may occur in variations to the sequence in accordance with various embodiments. Further, a detailed description related to the various steps of FIG. 5 is already covered in the description related to FIGS. 2-4 and is omitted herein for the sake of brevity.

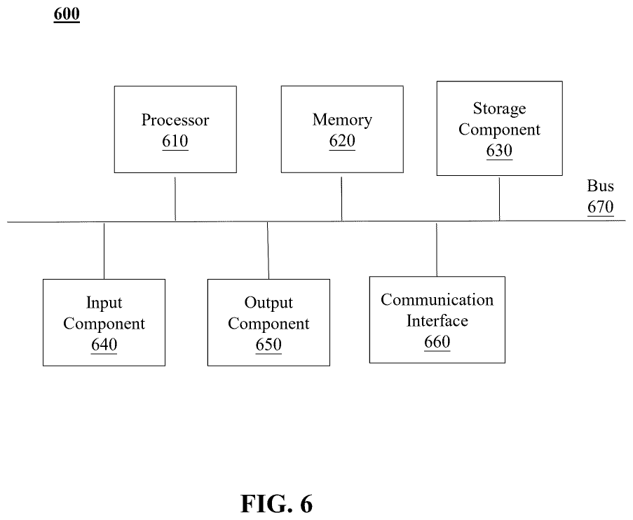

FIG. 6 is a diagram of example components of a wireless communication device 600 (also referred to as the device/apparatus 600), in accordance with an embodiment of the present disclosure. In one or more embodiments, the wireless communication device 600 may correspond to the eNBs 202 and/or the SMO 210. As shown in FIG. 6, the device 600 includes a processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single-core processor, or a combination of one or more multi-core processors and/or one or more single-core processors, a distributed processing system, or the like. The processor 610 may be a Central Processing Unit (CPU), a Graphics Processing Unit (GPU), an Accelerated Processing Unit (APU), an Application-Specific Integrated Circuit (ASIC), or another type of processing component.

The memory 620 includes a non-transitory computer-readable medium. The memory 620 includes a Random-Access Memory (RAM), a Read Only Memory (ROM), and/or another type of dynamic or static storage device (e.g., a flash memory, a magnetic memory, and/or an optical memory) that stores information and/or instructions for use by the processor 610. The memory 620 comprises machine-readable instructions which are executable by the processor 610. These machine-readable instructions when executed by the processor 610 cause the processor 610 to perform one or more method steps of an embodiment described above.

The storage component 630 stores information and/or software related to the operation and use of the device 600. For example, the storage component 630 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a Global Positioning System (GPS), an accelerometer, a gyroscope, and/or an actuator).

The output component 650 is configured to provide output information from the device 600. For example, the output component 650 maybe, but is not limited to, a display, a speaker, an instruction device to an external device, and/or one or more Light-Emitting Diodes (LEDs).

The communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, the device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600. Further, one or more method steps described in any of the embodiments may be performed utilizing a plurality of devices 600 in communication with one another.

It is understood that terms including “unit” or “module” at the end may refer to the unit for processing at least one function or operation and may be implemented in hardware, software, or a combination of hardware and software.

In one embodiment, an apparatus is described. The apparatus is configured to receive, from each of a plurality of eNodeBs (eNBs), mobility reject information and neighbor information. The apparatus is configured to identify a change in registered configuration for at least one eNB among the plurality of eNBs based on received mobility reject information and the neighbor information. The apparatus is configured to transmit, to each of the neighboring eNBs corresponding to the at least one eNB, at least one of a configuration change command and a notification. The configuration change command is transmitted to change the registered configuration of the at least one eNB at the corresponding neighboring eNB based on the identified change in the registered configuration. The notification indicates the change of the registered configuration of the at least one eNB.

The apparatus as described in [0051], wherein prior to receive the mobility reject information and the neighbor information, the apparatus is configured to:
establish a Network Configuration (NETCONF) session with each of the eNB.

The apparatus as described in any one of [0051]-[0052], wherein the apparatus comprises at least one rApp and the NETCONF session is established based on O1 interface standards.

The apparatus as described in any one of [0051]-[0053], wherein in response to the received mobility reject information and the neighbor information, the apparatus is configured to:
maintain a record corresponding to each eNB based on the received mobility reject information and the neighbor information.

The apparatus as described in any one of [0051]-[0054], wherein the apparatus is configured to receive the mobility reject information and the neighbor information after every predefined time interval configured at each of the plurality of eNBs.

The apparatus as described in any one of [0051]-[0055], wherein the apparatus is configured to receive the mobility reject information and the neighbor information in response to a change is identified by the corresponding eNB.

The apparatus as described in any one of [0051]-[0056], wherein the mobility reject information indicates a flag as true or false based on corresponding cell configuration as reserved or unreserved, respectively.

The apparatus as described in any one of [0051]-[0057], wherein the neighbor information indicates an un-preferred list of neighboring eNBs for a corresponding eNB among the plurality of eNBs.

The apparatus as described in any one of [0051]-[0058], wherein the apparatus corresponds to a Service Management and Orchestration (SMO).

In one embodiment, a method is described. The method includes receiving, by a Service Management and Orchestration (SMO), mobility reject information and neighbor information from each of a plurality of eNodeBs (eNBs). The method also includes identifying, by the SMO, a change in registered configuration for at least one eNB among the plurality of eNBs based on received mobility reject information and the neighbor information. The method includes transmitting, by the SMO to each of the neighboring eNBs corresponding to the at least one eNB, at least one of a configuration change command and a notification. The configuration change command is transmitted to change the registered configuration of the at least one eNB at the corresponding neighboring eNB based on the identified change in the registered configuration. The notification indicates the change of the registered configuration of the at least one eNB.

The method as described in [0060], wherein prior to receiving the mobility reject information and the neighbor information, the method comprises:
establishing, by the SMO, a Network Configuration (NETCONF) session with each of the eNB.

The method as described in any one of [0060]-[0061], wherein the NETCONF session is established based on O1 interface standards.

The method as described in any one of [0060]-[0062], wherein in response to the received mobility reject information and the neighbor information, the method comprises:
maintaining, by the SMO, a record corresponding to each eNB based on the received mobility reject information and the neighbor information.

The method as described in any one of [0060]-[0063], wherein the method comprises receiving the mobility reject information and the neighbor information after every predefined time interval configured at each of the plurality of eNBs.

The method as described in any one of [0060]-[0064], wherein the method comprises receiving the mobility reject information and the neighbor information in response to a change is identified by the corresponding eNB.

The method as described in any one of [0060]-[0065], wherein the mobility reject information indicates a flag as true or false based on corresponding cell configuration as reserved or unreserved, respectively.

The method as described in any one of [0060]-[0066], wherein the neighbor information indicates an un-preferred list of neighboring eNBs for a corresponding eNB among the plurality of eNBs.

A non-transitory computer-readable medium storing instructions is described. The instructions comprising: one or more instructions that are executed by a Service Management and Orchestration (SMO). The SMO comprising one or more processors. The instructions cause the one or more processors to receive, from each of a plurality of eNodeBs (eNBs), mobility reject information and neighbor information. The instructions cause the one or more processors to identify a change in registered configuration for at least one eNB among the plurality of eNBs based on received mobility reject information and the neighbor information. The instructions cause the one or more processors to transmit, to each of the neighboring eNBs corresponding to the at least one eNB, at least one of a configuration change command and a notification. The configuration change command is transmitted to change the registered configuration of the at least one eNB at the corresponding neighboring eNB based on the identified change in the registered configuration. The notification indicates the change of the registered configuration of the at least one eNB.

The non-transitory computer-readable medium as described in [0068], wherein prior to receiving the mobility reject information and the neighbor information, the instructions cause the one or more processors to:
establish a Network Configuration (NETCONF) session with each of the eNB.

The non-transitory computer-readable medium as described in any one of [0068]-[0069], wherein the SMO comprises at least one rApp and the NETCONF session is established based on O1 interface standards.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus configured to:
receive, from each of a plurality of eNodeBs (eNBs), mobility reject information and neighbor information;
identify a change in registered configuration for at least one eNB among the plurality of eNBs based on received mobility reject information and the neighbor information; and
transmit, to each of the neighboring eNBs corresponding to the at least one eNB, at least one of:
a configuration change command to change the registered configuration of the at least one eNB at the corresponding neighboring eNB based on the identified change in the registered configuration; and
a notification indicating the change of the registered configuration of the at least one eNB.

2. The apparatus as claimed in claim 1, wherein prior to receive the mobility reject information and the neighbor information, the apparatus is configured to:
establish a Network Configuration (NETCONF) session with each of the plurality of eNBs.

3. The apparatus as claimed in claim 2, wherein the apparatus comprises at least one rApp and the NETCONF session is established based on O1 interface standards.

4. The apparatus as claimed in claim 1, wherein in response to the received mobility reject information and the neighbor information, the apparatus is configured to:
maintain a record corresponding to each eNB based on the received mobility reject information and the neighbor information.

5. The apparatus as claimed in claim 1, wherein the apparatus is configured to receive the mobility reject information and the neighbor information after every predefined time interval configured at each of the plurality of eNBs.

6. The apparatus as claimed in claim 1, wherein the apparatus is configured to receive the mobility reject information and the neighbor information in response to a change is identified by the corresponding eNB.

7. The apparatus as claimed in claim 1, wherein the mobility reject information indicates a flag as true or false based on corresponding cell configuration as reserved or unreserved, respectively.

8. The apparatus as claimed in claim 1, wherein the neighbor information indicates an un-preferred list of neighboring eNBs for a corresponding eNB among the plurality of eNBs.

9. The apparatus as claimed in claim 1, wherein the apparatus corresponds to a Service Management and Orchestration (SMO).

10. A method comprising:
receiving, by a Service Management and Orchestration (SMO), mobility reject information and neighbor information from each of a plurality of eNodeBs (eNBs);
identifying, by the SMO, a change in registered configuration for at least one eNB among the plurality of eNBs based on received mobility reject information and the neighbor information; and
transmitting, by the SMO to each of the neighboring eNBs corresponding to the at least one eNB, at least one of:
a configuration change command to change the registered configuration of the at least one eNB at the corresponding neighboring eNB based on the identified change in the registered configuration; and
a notification indicating the change of the registered configuration of the at least one eNB.

11. The method as claimed in claim 10, wherein prior to receiving the mobility reject information and the neighbor information, the method comprises:
establishing, by the SMO, a Network Configuration (NETCONF) session with each of the plurality of eNBs.

12. The method as claimed in claim 11, wherein the NETCONF session is established based on O1 interface standards.

13. The method as claimed in claim 10, wherein in response to the received mobility reject information and the neighbor information, the method comprises:
maintaining, by the SMO, a record corresponding to each eNB based on the received mobility reject information and the neighbor information.

14. The method as claimed in claim 10, wherein the method comprises receiving the mobility reject information and the neighbor information after every predefined time interval configured at each of the plurality of eNBs.

15. The method as claimed in claim 10, wherein the method comprises receiving the mobility reject information and the neighbor information in response to a change is identified by the corresponding eNB.

16. The method as claimed in claim 10, wherein the mobility reject information indicates a flag as true or false based on corresponding cell configuration as reserved or unreserved, respectively.

17. The method as claimed in claim 10, wherein the neighbor information indicates an un-preferred list of neighboring eNBs for a corresponding eNB among the plurality of eNBs.

18. A non-transitory computer-readable medium storing instructions, the instructions comprising: one or more instructions that, when executed by a Service Management and Orchestration (SMO), the SMO comprising one or more processors, cause the one or more processors to:
receive, from each of a plurality of eNodeBs (eNBs), mobility reject information and neighbor information;
identify a change in registered configuration for at least one eNB among the plurality of eNBs based on received mobility reject information and the neighbor information; and
transmit, to each of the neighboring eNBs corresponding to the at least one eNB, at least one of:
a configuration change command to change the registered configuration of the at least one eNB at the corresponding neighboring eNB based on the identified change in the registered configuration; and
a notification indicating the change of the registered configuration of the at least one eNB.

19. The non-transitory computer-readable medium as claimed in claim 18, wherein prior to receiving the mobility reject information and the neighbor information, the instructions cause the one or more processors to:
establish a Network Configuration (NETCONF) session with each of the plurality of eNBs.

20. The non-transitory computer-readable medium as claimed in claim 19, wherein the SMO comprises at least one rApp and the NETCONF session is established based on O1 interface standards.
